(19) United States
(12) Patent Application Publication
(10) Pub. No.: US 2026/0211143 A1
(43) Pub. Date: Jul. 23, 2026

(54) METHOD FOR CROSS-CORRELATING RECEIVER SIGNALS

(71) Applicant: FNV IP B.V., Leidschendam (NL)

(72) Inventors: Francois JANOD, Leidschendam (NL); Myrna STARING, Leidschendam (NL); Rod EDDIES, Leidschendam (NL)

(73) Assignee: FNV IP B.V., Leidschendam (NL)

(21) Appl. No.: 19/138,894

(22) PCT Filed: Dec. 19, 2023
(86) PCT No.: PCT/EP2023/086518

§ 371 Date: Jun. 13, 2025

(30) Foreign Application Priority Data
Dec. 23, 2022 (NL) 2033827

(51) Int. Cl. G01V 1/36; G01V 1/30

(52) U.S. Cl. CPC G01V 1/366; G01V 1/306

(57) ABSTRACT

A computer-implemented method of cross-correlating signals detected by geophones is disclosed. The method comprises receiving signal data comprising a plurality of signals detected by a plurality of geophones arranged on a surface, determining an amount of processing resource that is available for processing the received signal data, and splitting the received signal data into a plurality of signal data subsets based on the determined amount of available processing resource. The method further comprises cross-correlating, using the available processing resource, pairs of signal data subsets such that each signal data subset is cross-correlated with every other signal data subset and with itself, wherein cross-correlating a pair of signal data subsets comprises cross-correlating each signal in the first subset of the pair with every signal in the second subset of the pair, and outputting a Green's function resulting from each cross-correlation. Unlocking insights from Geo-Data, the present invention further relates to improvements in sustainability and environmental developments: together we create a safe and liveable world.

### FIELD

The disclosure relates to methods and systems for analysing a target region beneath a surface of the earth. More particularly, the disclosure relates to a method and system for determining one or more ground properties of the sub-surface target region based on ambient noise measured at or near the surface. In particular, the disclosed methods and systems relate to cross-correlation of ambient noise signals measured by receivers such as geophones. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide information useful for infrastructure planning. Determination of sub-surface ground properties during the early planning phase of construction projects reduces uncertainty during the location determination, foundation design, and construction phases of a project. This in turn reduces delays, overspend, and unnecessary use of material resources (e.g. concrete) during construction.

One key parameter for the determination of ground characteristics in a volume of interest is shear-modulus and shear-velocity Vs. The shear velocity Vs is the velocity at which a shear wave moves through the material and is controlled by the shear modulus of the material. The relationship between shear-velocity and shear modulus G is defined by Vs=√G/ρ, where ρ is the density of the material. Measurement of Vs therefore provides a valuable insight to the material properties of a sub-surface ground region.

Spectral analysis of surface waves (SASW) and multi-channel analysis of surface waves (MASW) are both examples of techniques for gathering surface wave information that can be used in the determination of ground properties in a sub-surface volume. In both of these techniques, surface-level vibrations resulting from an active source (e.g. a weight drop) are measured from and the dispersion of the resulting surface waves is studied. ReMi (Refraction Microtremor) is another surface-level technique that uses ambient noise and surface waves to infer ground properties of a sub-surface region based on the observation of ambient noise at the surface.

Down-hole and cross-hole techniques can also be used to determine ground properties of a sub-surface region. In both of these methods, a receiver located in a bore hole measures waves received from an active source located elsewhere. In a down-hole technique, one of the source and the receiver is located at a sub-surface location within the bore hole and the other of the source and the receiver is located at the surface. In a cross-hole technique, a source is located in a first bore hole, with a receiver located in a second bore hole. In both down-hole techniques, the propagation and dispersion of the received waves are studied to infer the properties of the material through which the waves from the receiver have travelled.

Invasive techniques for measuring material ground properties of a sub-surface region can often present logistical challenges such as long duration of the processes and thus low cost efficiency, e.g. long process set-up, long acquisition times and/or heavy machinery, equipment and processes. Invasive techniques are often particularly undesirable, especially in urban or inaccessible environments, and are often prohibitively expensive. Invasive techniques may also be unfriendly to the environment, e.g. cause disturbance to the local fauna. Conversely, current surface-level techniques may lack the accuracy and reliability of more invasive analysis techniques.

Additionally, there is a need to reduce the amount of processing required in the determination of sub-surface ground properties as known techniques require significant computing overhead.

### Overview

According to a first aspect of the present disclosure, there is provided a computer-implemented method of cross-correlating signals detected by receivers. The receivers, which may also be considered to be sensors, may be geophones, accelerometers, seismometers, vibration sensors and/or transducers. The method comprises: receiving signal data comprising a plurality of signals detected by a plurality of receivers arranged on a surface; determining an amount of processing resource that is available for processing the received signal data; and splitting the received signal data into a plurality of signal data subsets based on the determined amount of available processing resource. Typically, each signal in the signal data is indicative of the ambient noise measured at or near the surface by the respective receiver which recorded the signal. The method further comprises: cross-correlating, using the available processing resource, pairs of signal data subsets such that each signal data subset is cross-correlated with every other signal data subset and with itself, wherein cross-correlating a pair of signal data subsets comprises cross-correlating each signal in the first subset of the pair with every signal in the second subset of the pair; and outputting a Green's function resulting from each cross-correlation.

This method makes computation of the Green's functions for receiver pairs more feasible and efficient. Rather than dealing with an entire matrix of cross-correlations in one go, the signal data is split into subsets. These subsets are then handled independently. This can be done in a vectorised manner and by multiple processors in parallel as described in more detail below, significantly improving the efficiency and feasibility of the computation. These efficiency savings are particularly important in the context of receiver arrays because the amount of data contained in the signal data is very large due to the high number of receivers present in a typical array and the fact that each signal contains a large number of samples. Note that the term “pair” herein simply means that the signals of two signal data subsets are cross-correlated. The subsets can be different or the same, i.e. “pair” does not imply that the subsets have to be the same or a different subset; they can be either, as described more fully below.

In some implementations, the signal data comprises N signals. Typically, these N signals correspond to N receivers in a one-to-one relationship, i.e. one signal per receiver. Splitting the received signal data into a plurality of signal data subsets may comprise splitting the received signal data into K signal data subsets. In that case, the number of signals in each subset may advantageously be selected to be equal to either

$$[ \frac{N}{K} ] - 1 or [ \frac{N}{K} ] ,$$

where the operator [ ] indicates rounding up to the next integer value. This ensures that subsets are all similarly sized, which makes the computation more efficient when parallelisation is utilised. This approach avoids the scenario where some subsets are very big and others very small, which would be inefficient in terms of balancing computation across the available computing resources. Ensuring a subset size of either

$$[ \frac{N}{K} ] - 1 or [ \frac{N}{K} ]$$

ensures similarity in subset sizes resources.

In some implementations, determining an amount of processing resource that is available for processing the received signal data comprises determining: a number of available processors, N_{proc}; and an amount of available random access memory, RAM. This makes effective parallelisation possible because the number and size of subsets can be adapted to the available number of processors and RAM, as described in more detail below.

In some implementations, splitting the received signal data into a plurality of signal data subsets comprises splitting the received signal data into K signal data subsets, where K is chosen according to:

$$K \geq CN \sqrt{\frac{{MDN}_{p r o c}}{R A M}}$$

where
C is a constant to account for ad-hoc memory requirements;
N is the number of signals comprised in the signal data;
M is the number of samples in each signal;
D is the storage file size of each sample;
N_{proc} is the number of available processors; and
RAM is the amount of available random access memory, RAM.

This approach allows the number of subsets to be chosen in a way that matches well the available processing resources (i.e. RAM and number of processors). Ensuring K obeys this inequality ensures there will be sufficient processing resource to efficiently compute each subset of the signal data.

In some implementations, the cross-correlating is performed by a plurality of processors. This enables parallelisation of processing, making the computation faster and more efficient and meaning that a large matrix of receiver signals can be processed more effectively.

In some implementations, all cross-correlations for a given pair of signal data subsets are performed by the same processor. These cross-correlations may be considered a “block” of cross-correlations, as described in more detail below. Ensuring that each block of cross-correlations is performed by a single processor improves efficiency because each block can be independently computed by a given processor in an efficient manner independently of the computation of the other blocks.

In some implementations,

$$\frac{K ( K + 1 )}{2}$$

defines the number of “blocks”. Advantageously, the number of subsets, K, may then be chosen such that

$$\frac{K ( K + 1 )}{2}$$

is a multiple of the number of available processors, N_{proc}. By ensuring the number of blocks is a multiple of N_{proc}, computation of the blocks can be spread evenly between the processors.

In some implementations, each processor performs its cross-correlation(s) independently of and/or in parallel to the other processors. The ability for multiple processors to each work independently and in parallel on separate, independent subsets is one of the key advantages provided by the disclosed methods and significantly increases computing efficiency and speed when processing the receiver signals.

In some implementations, each signal data subset is only cross-correlated once with itself and with every other signal data subset. This is made possible by symmetry of the cross-correlation matrix as explained in more detail below. This means fewer cross-correlations need to be computed, saving computing resources and memory. This makes the method more efficient and less computationally expensive.

In some implementations, a mapping function is used to map each signal within a given subset to a particular receiver. This allows the system to efficiently map between the “local” view-used when computing a particular subset- and the “global” view—i.e. a signal within the context of all the signal data as a whole, which identifies a particular receiver.

The method may further comprise storing each Green's function in memory alongside an indicator mapping the Green's function to a particular pair of receivers. This makes it easier to find and reconstruct the data for a particular pair of receivers in future, for example when the Green's function data is to be used for sub-surface analysis.

In some implementations, the cross-correlating is performed in the frequency domain and the resulting Green's functions are frequency domain Green's functions. Performing the cross-correlations in the frequency domain is advantageous because frequency domain computation enables faster processing. In particular, for M samples per receiver signal, frequency domain calculation is faster by O(M) vs O(M²) for time domain, where O is the Landau notation for asymptotic behaviour of a function. This leads to a gain in computation speed because the fast Fourier transform (that has then to be done previously) is an O(M log (M)) process, in other words computation time is growing with M in the same way as M log (M). The computation also has to be done only once per receiver. Hence, global Fourier transform computation time is negligible as compared to the time domain computation time.

In some implementations, the method may further comprise determining a model of ground properties of a sub-surface target region based on the Green's functions. The ground property may comprise shear wave velocity, Vs, or shear modulus. The model may be a 3D model. In one example, the method comprises determining one or more velocity dispersion profiles as a function of sensed surface wave frequency, based on the determined cross-corelated signals; generating a 3-dimensional phase velocity dispersion profile from the first and second phase velocity dispersion profiles; determining a plurality of group velocity dispersion profiles as a function of sensed surface wave frequency; generating a respective shear wave velocity model as a function of depth from the 3 dimensional phase velocity dispersion profile and each group velocity dispersion profile; and generating a 3 dimensional shear wave velocity model as a function of depth from the respective shear wave velocity models. The shear wave velocity model may be used in a workflow process for determining the location or design requirements of one or more construction projects.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer-readable medium comprising instructions, that, when executed by one or more data processing apparatus, cause the one or more data processing apparatus to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which:

FIG. 1 shows a cross-sectional view of a sub-surface target region with a plurality of receivers arranged at the surface;

FIG. 2 shows a plot identifying the ray paths between a plurality of receivers;

FIG. 3 shows the cross-correlation of N receiver signals represented as an N by N matrix;

FIG. 4 shows a reduced version of the matrix of FIG. 3;

FIG. 5 shows a method of cross-correlating receiver signals according to the present disclosure;

FIG. 6 shows the matrix of FIG. 4 divided into a plurality of signal data subsets, each signal subset pair having a corresponding cross-correlation block in the matrix;

FIG. 7 shows the matrix of FIG. 6 with each cross-correlation block numbered for ease of understanding;

FIG. 8 shows a single cross-correlation block from the matrix of FIG. 7, where m #n;

FIG. 9 shows a single cross-correlation block from the matrix of FIG. 7, where m=n;

FIG. 10 shows a 3D model of seismic shear-wave velocity (Vs) for a sub-surface target region; and

FIG. 11 shows a block diagram of a computing device which can be used to implement the disclosed methods.

### DETAILED DESCRIPTION

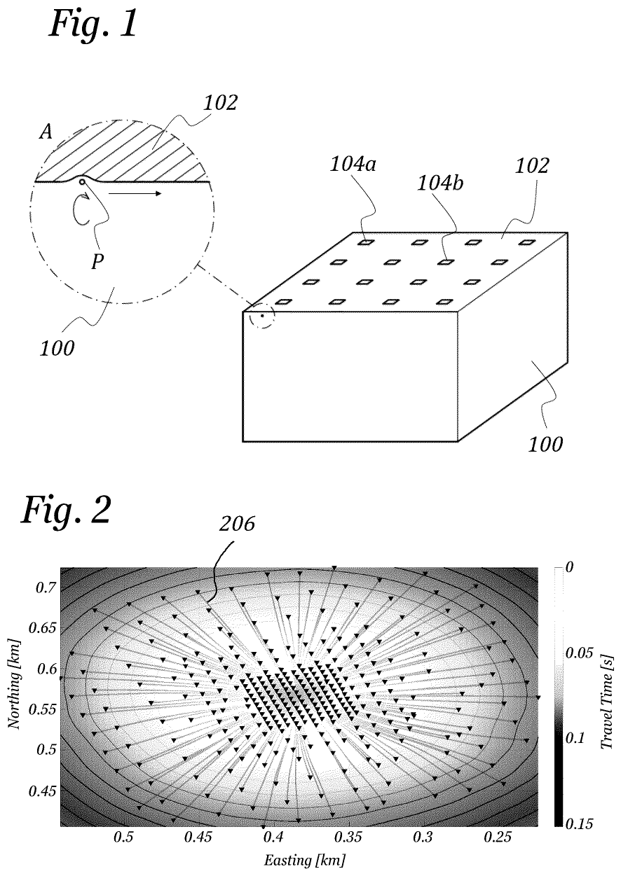

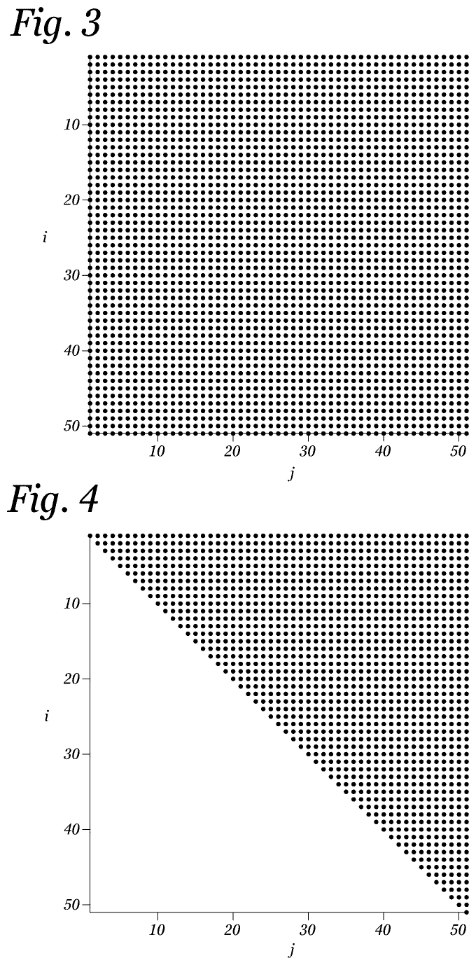

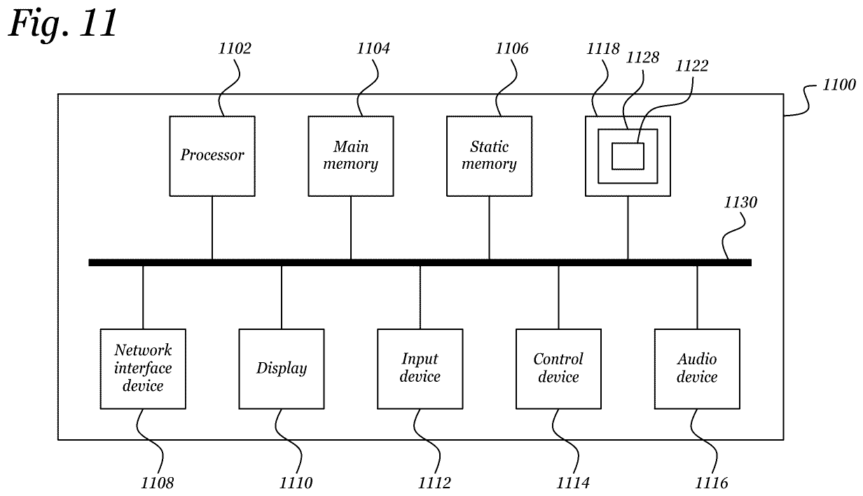

This detailed description describes, with reference to FIGS. 1 and 2, an approach to measuring structural properties of a ground volume using receivers. Next, with reference to FIGS. 3-9, novel methods for performing cross-correlation of signals detected by receivers are disclosed. An example output that may be generated from the obtained Green's functions is shown in FIG. 10. Finally, a computing device that may be used to perform the disclosed methods is described with reference to FIG. 11.

The following examples will be described in the context of a geophone array, to aid understanding. It will, however, be appreciated that the disclosed systems and methods are applicable to a variety of receiver types, including but not limited to geophones, accelerometers, seismometers, vibration sensors and/or transducers. The disclosed methods may be applied to cross-correlation of any suitable set of signals.

The methods and systems disclosed herein relate generally to cross-correlation of signals detected by geophones on a surface. In one particular example, the geophones are placed on a ground surface and the detected signals are ambient noise signals. Cross-correlation of these signals provides useful insight into the structure of the surface and sub-surface volume on which the geophones are placed, as described in more detail below. Due to the potentially very large number of signals being cross-correlated, however, methods are needed to ensure that cross-correlation of these signals is computationally feasible. The disclosed methods and systems provide such a mechanism for performing the required cross-correlations in a computationally efficient and practically feasible manner.

Before turning to the details of the disclosed cross-correlation methodology, some background relating to determination of surface and sub-surface properties using geophones will first be provided.

The present disclosure describes systems and method for determining the ground properties of a sub-surface volume. Although, it will be appreciated that the methods herein may be applied to model physical properties other than shear velocity, such as compressional wave velocity, density, elastic modulus, or, if a viscoelastic model is being used, optionally also viscosity coefficients Qₛ and Qₚ. In general, the model may define multiple physical property values, the focus of the following detailed description will be the determination of shear velocity, and the related quantity, shear modulus.

Shear modulus is a measure of the elastic shear stiffness of a material and represents the deformation of a solid when it experiences a force parallel to one of its surfaces while its opposite face experiences an opposing force. Such forces and their effects in sub-surface ground volumes, are an important parameter for study before and during the design of building and infrastructure projects. To determine the shear modulus of a volume, the shear velocity, Vs, is determined. This in turn gives an indication of the stiffness of the sub-surface material, and its ability to support structures extending above and/or through the volume.

In the context of ground study, two types of waves are generally distinguished: P-waves, in which particles in the volume oscillate in the direction of movement of the wave, cause a compression and de-compression of the ground as the waves propagate through the ground. S-waves are shear waves, in which particles oscillate in a direction perpendicular to the direction of propagation of the waves.

P-waves and S-waves are body waves and propagate in all directions through the body of the volume. The interaction of P- and S-waves with the earth's surface generates surface waves, which propagate along that surface. Several types of surface waves can be distinguished. In the systems and methods described herein, Rayleigh waves are measured and studied because it is convenient to measure the vertical component of surface vibrations. However, it will be appreciated that other surface waves (e.g. Love waves) may be measured and harnessed in the systems and methods described herein.

Because surface waves propagate in 2D (at the surface), they attenuate less rapidly than body waves (which propagate in 3D). Surface waves are generally present within a depth range of one wavelength from the surface, generally travel more slowly and have a predominantly lower frequency than body waves. This lower attenuation, slower travel time and lower frequency of surface waves makes their study particularly attractive for the purposes of determining shear velocity, Vs. Since the surface waves have lower attenuation, the signal strength is better maintained through over a longer travel distance. The resulting measurement results therefore generally have a higher signal quality (signal-to-noise ratio) than body wave studies.

The methods and systems of the present disclosure harness the study of surface waves to provide insight into the ground properties of a sub-surface target volume. In general terms, the present disclosure provides methods for analysing one or more ground properties, such as the shear-wave velocity, Vs, of a sub-surface target region. The method involves receiving a data set indicative of ambient noise at a surface above a sub-surface target region, analysing the background wavefield to study the dispersive behaviour of the surface waves measured at the surface, and determining the ground properties of the sub-surface target region based on the study of the dispersive behaviour of the observed waves.

Referring now to FIG. 1, a cross-sectional view of a sub-surface volume 100 is shown. A surface 102 extends above the sub-surface volume. Surface waves propagate along the surface 102, as shown at point A, where a schematic representation of a particle oscillation (due to Rayleigh wave propagation) at the surface above the target sub-surface volume is shown. As illustrated, the oscillation of the particle P is partly vertical, partly in the direction of propagation and movement is therefore substantially ellipsoid.

At a surface 102 above the volume 100, a plurality of receivers 104a, 104b is arranged in a 2D array. The receivers (collectively referred to as 104) may be geophones configured to measure the vertical component of the surface waves propagating across the surface 102. However, it will be appreciated that the propagation of surface waves may also be measured with alternative sensing means, for example: accelerometers, seismometers, vibration sensors, and/or transducers.

The receivers 104 are configured to measure ambient noise. That is, the wavefield present due to background noise (as opposed to noise from an active source such as a hammer drop or explosion). The background noise may be natural (e.g. due to lapping ocean waves, wind, and other naturally occurring vibrations) or cultural (e.g. due to human activity, including traffic, machinery, etc.).

As shown in FIG. 1, the receivers 104 are arranged in a grid array at the surface, the grid extending in two directions. It should be noted that the surface above the target region may, in many cases, not be planar. The array of receivers 104 may therefore not be truly “2-dimensional” (each receiver may be offset from its neighbours in the grid in the z-direction, as well as the x- and y-directions). However, such a grid arrangement of receivers will be referred to as a 2D array herein. It will also be appreciated that in the context of sub-surface ground study, the term 2D array may also be used to denote an array configured to capture 2D information (e.g. a line of receivers configured to provide information regarding a 2D slice of a target region) and a 3D array may refer to a grid of receivers configured to capture 3D information. However, in the context of the present information, the term 2D in the context of receivers is intended to refer to the 2-dimensional configuration of the receivers rather than the information gathered.

Moreover, although the receivers 104 are shown at the surface in FIG. 1, the receivers 104 may also be disposed near the surface (e.g. partially buried, or immediately beneath the surface). In the context of the present application, ‘at the surface’ will be understood to mean at or near the surface, such that the receivers measure surface waves.

In the schematic shown in FIG. 1, the receivers 104 are arranged in a regular grid, with the inter-receiver distance equal across surface 102. However, in some implementations, the receivers 104 are arranged with varying density across the surface 102.

The array of receivers 104 shown in FIG. 1 can be used to gather a data set indicative of ambient noise at a surface above a sub-surface target region for which a model of shear velocity Vs is desired that is the subject of the present application.

To determine the shear velocity from the observation of surface waves (in particular Rayleigh waves), the dispersive behaviour of the surface waves is studied. Surface waves are dispersive, i.e. their velocity is dependent on frequency. Since seismic velocities increase with depth in the earth, normal surface wave dispersion shows a decrease of surface-wave velocity with increasing frequency. It is by studying the behaviour of surface waves at a surface above a volume that the ground properties of the volume can be determined.

There are two ways to measure the velocity of dispersive surface waves and a distinction is made between the determination of group velocity or phase velocity.

The group velocity of a wave is the velocity with which the overall envelope shape of the wave's amplitudes-known as the modulation or envelope of the wave-propagates through space. The group velocity is equivalent to the speed with which the energy of the wave propagates through the volume and is measured by determining the wave propagation between two points. The group velocity is obtained as a time-of-flight (that is, travel time) measurement between a (virtual) source and a receiver.

The phase velocity is the velocity at which the phase of any one frequency component of the wave travels. As such, the phase velocity is expressed as a function of frequency. To measure the phase velocity, at least two measurement nodes (e.g. receivers) are chosen to measure the waves propagating through the volume to determine relative time-of-flight between the nodes for different frequencies. The result is the phase velocity as a function of frequency as averaged over the volume between the two measurement nodes. Phase velocity is acquired as a point in 2D phase space (dispersion spectrum) which is itself obtained by a 2D transform (such as slant-stack, Radon, FK, or the like) of an array of recorded waveforms (time-distance space). The wavelength of the surface wave is indicative of its propagation depth. As a result, the phase velocity as a function of frequency is indicative of the shear velocity Vs as a function of depth.

The receivers 104 at surface 102 provide the measurement nodes for the study of the surface wave behaviour as described above. However, the receivers 104 described above are configured to record passive noise. Therefore, the measurement nodes of FIG. 1 do not represent a real point source and associated receiver. However, receivers 104 can act as a virtual source receiver pair, as explained below.

Receivers 104a and 104b form a first receiver pair in the array at surface 102. Neither receiver 104a nor 104b represents a point source for noise recorded at the other of receiver 104a, 104b. However, by cross-correlating the received signal at receiver 104a and 104b, receivers 104a and 104b can act as a (virtual) source receiver pair, where each receiver of the pair records a signal as though the signal had originated at the other of the pair. The cross-correlation is performed using the principle of interferometry.

The cross-correlation of passive noise measured at respective pairs of receivers at the surface shown in FIG. 1 can be used to reproduce a response from the sub-surface target volume, as if it were induced by an impulse point source, which is equal to Green's function.

In other words, a response that is received by cross-correlating two receiver recordings can be interpreted as a response that would have been measured at one of the receiver locations as if there were a source at the other. Various approaches to determining the Green's function for a virtual source-receiver pair are known, with an overview of the approaches described in “Tutorial on Seismic Interferometry: Part 1—Basic Principles and Applications”; GEOPHYSICS. Vol. 75, No 5 (September-October 2010; P. 75A195075A209; Wapenaar et al.).

In FIG. 1, only one pair of receivers is labelled (104a, 104b). However, it will be appreciated that for each receiver 104 in the array, every other receiver in the array may act as the other half of a source receiver pair. In this manner, the Green's function for each source receiver pair may be obtained. The Green's functions across the plurality of virtual source receiver pairs is studied to determine the dispersive behaviour of the surface waves.

FIG. 2 shows a plurality of virtual source-receiver pairs across a surface above a sub-surface region of interest. Ray paths 206 between source-receiver pairs are indicated. Note that the ray paths here indicate the propagation of a wave (modelled from) a virtual source at a receiver in a centre of the plot to each of the other receivers in the array. The receivers are not labelled individually but are represented with an inverted triangle in the plot. Each receiver can similarly act as a point source. As can be seen from FIG. 2, the array of receivers allows source receiver pairs defining ray paths that extend in different directions, and with varying inter-receiver spacing. The background shading and contour rings indicate the travel-time field from the central receiver to the other receivers 104. There are also corresponding ray paths between each receiver and all other receivers, i.e. between every pair of receivers. These ray paths are not depicted in FIG. 2 for simplicity.

As described above, cross-correlating signals obtained by receivers (e.g. geophones 104 in FIG. 1) and obtaining resulting Green's functions enables useful sub-surface investigation to be performed. In practice, however, there may be up to several thousand receivers 104 provided in each array. To obtain a complete data set, the signal measured at each receiver 104 must be cross-correlated with the signal measured at each other receiver 104 in the array, as well as with itself. Each measured signal is typically recorded over a time period of a day or so, at a sampling frequency that is usually between 100 Hz and 500 Hz. As a result, the signal for each receiver, which may in some contexts be referred to as a “data trace”, may comprise on the order of 20 million samples, when taking a typical sampling frequency of 250 Hz. It will be appreciated that, as the number of receivers increases, cross-correlation of the signals, each containing perhaps 20 million samples, rapidly becomes very computationally expensive. In particular, a prohibitive amount of memory is required to cross-correlate the entire array. Merely as an example, taking an array of 1000 receivers would result in 10002 cross correlations, with each receiver signal comprising around 2×10⁷ samples as noted above. This results in a computation involving around 2×10¹³ data points. As a result of this very large number of data points, cross-correlation of a large array of receiver signals may be practically infeasible within an acceptable timeframe for all but the most powerful computing systems. The approach disclosed herein addresses this problem by providing methods which make the cross-correlation more efficient and computationally feasible for more commonplace computing hardware.

The disclosed approach will now be described with reference to FIGS. 3-9. The disclosed approach to cross-correlation of the receiver signals may be understood more easily if the cross-correlations are represented as a 2D matrix, as shown in FIG. 3. In the example shown, the number of receivers, N, is 51. As noted above, in reality N may be significantly higher, typically on the order of several thousand. The reduced number N=51 is chosen in FIG. 3 simply to aid understanding.

As can be seen, the cross correlation between each receiver signal with every other receiver signal (plus itself) can be represented in a 2D matrix, with N receivers on the X-axis and N receivers on the Y-axis. Each point in the 2D matrix then represents a respective cross-correlation between a pair of receiver signals. For example, the top-left point in the 2D matrix represents the cross-correlation of the signal from receiver 1 with itself, i.e. i=1 and j=1. The point immediately to the right of this represents the cross-correlation of the signal from receiver 1 with the signal from receiver 2, i.e. i=1 and j=2. The top-right point in the 2D matrix represents the cross-correlation of the signal from receiver 1 with the Nth receiver, i.e. i=1 and j=N and so on.

As noted above, cross-correlation of each signal pair can be used to generate a Green's function for the respective pair of receivers. The Green's function for a receiver pair is defined as:

$${G}_{i j} = {S}_{i}^{*} \cdot {S}_{j} , i = 1 … N , j = 1 … N \qquad ( 1 )$$

where Gᵢⱼ is the Green's function generated by cross correlation of receiver signal Sᵢ with receiver signal Sⱼ in the frequency domain. i and j respectively correspond to the receiver indices shown in FIG. 3 and used to map the N receivers into a 2D matrix. The operator * represents the complex conjugate here and throughout this disclosure.

As noted above, the present inventors have identified that cross-correlation of the entire 2D matrix of signals in a single, brute-force manner is computationally infeasible when N increases. Even for the relatively small 51×51 matrix shown in FIG. 3, there are already 2601 cross-correlations, and each signal comprises M samples, where M is typically around 10⁷ as explained above. As N increases, the computational burden of performing all these cross-correlations rapidly becomes infeasible without efficiency mechanisms to make the computation more manageable.

In order to make the cross-correlation more computationally feasible, the present inventors have identified a number of simplifying steps which can be performed to break the computational task into manageable chunks. A first realisation made by the present inventors is that the 2D matrix of cross-correlations is symmetric. In more formal terms, the matrix is self-adjoint. This means that the following holds:

$${G}_{i j} = {G}_{j i}^{*} \qquad ( 2 )$$

Because of this symmetry, the present inventors have identified that each receiver signal only needs to be cross-correlated once with itself and with each other signal in the signal data. In other words, once

$${G}_{1 , 2} = {S}_{1}^{*} \cdot {S}_{2}$$

has been computer, it is not necessary to also compute

$${G}_{21} = {S}_{2}^{*} \cdot {S}_{1}$$

because the result is straightforwardly attainable as

$${G}_{2 , 1} = {G}_{1 , 2}^{*} .$$

As a result, a significant reduction in the number of cross-correlations that need to be performed is achieved. In particular, rather than N² cross-correlations, the number of cross-correlations required is in fact

$$\frac{N ( N + 1 )}{2} .$$

This reduced number of cross-correlations is shown in FIG. 4. In this manner, only 1326 rather than 2601 cross-correlations need to be performed when N=51. It will be appreciated that this near-halving of the required cross-correlations becomes increasingly beneficial the higher N becomes.

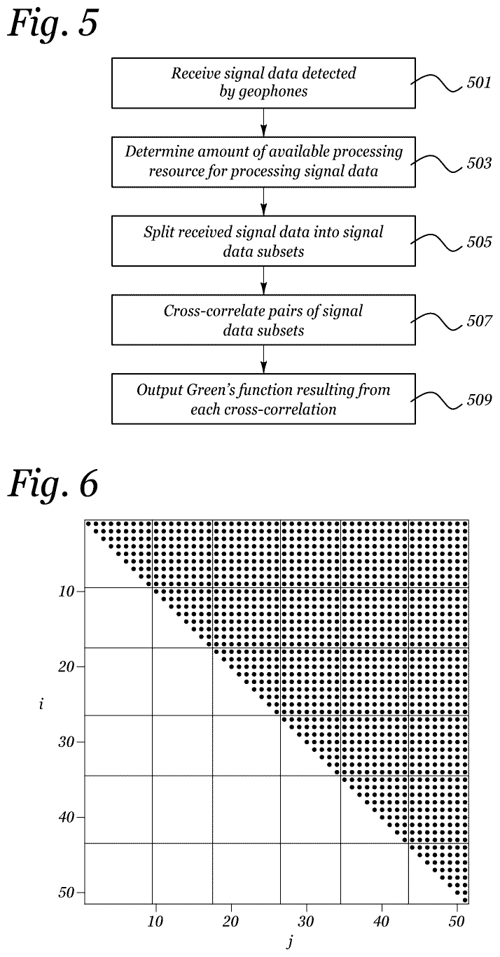

A method for computing the cross-correlations will now be described with reference to FIG. 5. For completeness, it is noted that reducing the matrix of cross-correlations as shown in FIG. 4 is not a pre-requisite of the method of FIG. 5. Rather, the approaches of FIGS. 4 and 5 can be combined to provide increased computational efficiency. The method of FIG. 5 may be performed by one or more computing devices, as will be explained in more detail below.

The method of FIG. 5 begins, at step 501, by receiving signal data comprising a plurality of signals detected by a plurality of receivers arranged on a surface, for example receivers 104 of FIG. 1. In particular, N signals are received, one from each of the N receivers in the plurality. In the case of FIGS. 3 and 4, therefore, the signal data received at step 501 would contain 51 signals. Typically, each signal in the signal data is indicative of the ambient noise measured at or near the surface by a respective receiver. As noted above, each signal is typically captured over an extended time period, such as a day, and typically comprises M samples. The exact number of samples in each signal is determined by the sampling frequency of the receivers.

At step 503, an amount of processing resource that is available for processing the received signal data is determined. In particular, it can be determined how many processors, defined as N_{proc}, and how much random access memory, RAM, is available to perform the required cross-correlation of the N signals. Then, at step 505, the received signal data is split into a plurality of signal data subsets based on the determined amount of available processing resource. In other words, the signal data received at step 501 can be broken up into chunks based on the amount of processing resource that is determined to be available at step 503. This approach is highly advantageous because the computational burden of the subsequent cross-correlation of the signal data (at step 507) can be efficiently divided between the available processing resources. For example, if six available processors are identified at step 503, then the signal data can be divided into six (or a multiple of six) subsets at step 505 such that the computation can be efficiently shared between the available processors. This approach will be described in more detail below.

The number of subsets that the signal data is split into may be labelled as K. In one example, splitting of the signal data into subsets at step 505 can be based on the following expression:

$$K \geq C N \sqrt{\frac{{MDN}_{proc}}{R A M}} \qquad ( 3 )$$

where
K is the number of subsets;
C is a constant to account for ad-hoc memory requirements;
N is the number of signals comprised in the signal data;
M is the number of samples in each signal;
   D is the storage file size of each sample;
   N_{proc} is the number of available processors; and
   RAM is the amount of available random access memory, RAM.
   This expression provides an efficient mechanism for determining how many subsets to split the signal data into, such that the number of signal data subsets efficiently matches the available processing resources (i.e. RAM and number of processors). Ensuring K obeys this inequality ensures there will be sufficient processing resource to efficiently compute the signal data. It is to be noted that the constant C is provided to account on an ad-hoc basis for any additional processing requirements that may be present as a result of processing other inputs or outputs at the time of computation. These requirements, and thus the value of C, will vary on a case-by-case basis depending on the computing context.

It is beneficial if the subsets each contain a similar number of respective signals. This ensures that subsets require equal amounts of computing resource to cross-correlate, allowing more efficient distribution of computation between the available computing resources. In one example, an even distribution of signals between subsets can be ensured by setting the number of signals in each subset as equal to either:

$$[ \frac{N}{K} ] - 1 or \qquad ( 4 a )$$

$$[ \frac{N}{K} ] \qquad ( 4 b )$$

where the operator [ ] indicates rounding up to the next integer value.

FIG. 6 shows the 2D cross-correlation matrix of FIG. 4 split into subsets. In this example K=6, in other words the signal data has been split into six subsets. These subsets are shown schematically in FIG. 6 by the introduction of vertical and horizontal lines showing the subset division on both the X and Y axis. In this case, the choice of six subsets is beneficial because, in this example, three processors are available to process the cross-correlations. By splitting the signal data into six subsets, it is ensured that

$$\frac{K ( K + 1 )}{2}$$

is a multiple of the number of processors available. This means that an even distribution of computation across the available computing resources can be ensured, as explained in more detail below. An even distribution of computation improves the computational efficiency. In the example of FIG. 6, equations 4a and 4b were also used to ensure that subsets are as evenly distributed as possible. In particular, each subset contains 8 or 9 signals in this example, ensuring that computation of each subset takes approximately the same amount of processing time.

In the example of FIG. 6, the six subsets are defined as follows:

$$N = 1 … 9 \qquad subset 1$$

$$N = 10 … 17 \qquad subset 2$$

$$N = 18 … 26 \qquad subset 3$$

$$N = 27 … 34 \qquad subset 4$$

$$N = 35 … 43 \qquad subset 5$$

$$N = 44 … 51. \qquad subset 6$$

Returning now to the method of FIG. 5, once the signal data has been split into subsets at step 505 in the manner shown in FIG. 6, the method proceeds, at step 507, to cross-correlate, using the available processing resource, pairs of signal data subsets such that each signal data subset is cross-correlated with every other signal data subset and with itself. Cross-correlation of each pair of signal data subsets involves cross-correlating each signal in the first subset of the pair with every signal in the second subset of the pair. A Green's function for a particular pair of receivers can be obtained from each cross-correlation, and each obtained Green's function can be output at step 509.

Returning to the example of FIG. 6, the cross-correlation at step 507 involves cross-correlating the signals of subset 1 with the signals of subset 2, the signals of subset 1 with the signals of subset 3, and so on until each pair of subsets has been cross-correlated and each subset has been cross-correlated with itself. In the context of the 2D matrix representation of FIG. 6, each pairwise cross-correlation of the signals in a pair of subsets can be considered to involve computation of a “block” of cross-correlations. Dividing the matrix of cross-correlations into such blocks facilitates effective distribution of computations between available computing resources, as will be described more fully below.

If the entire N by N matrix were cross-correlated, there would be K² blocks to compute. However, as described above, for symmetry reasons it is not necessary to compute every cross-correlation. In particular, there is no need to cross-correlate subset 2 with subset 1 if subset 1 has already been cross-correlated with subset 2. Rather, each signal data subset only needs to be cross-correlated once with itself and with every other signal data subset. Accordingly, rather than K² blocks, there are in fact only

$$\frac{K ( K + 1 )}{2}$$

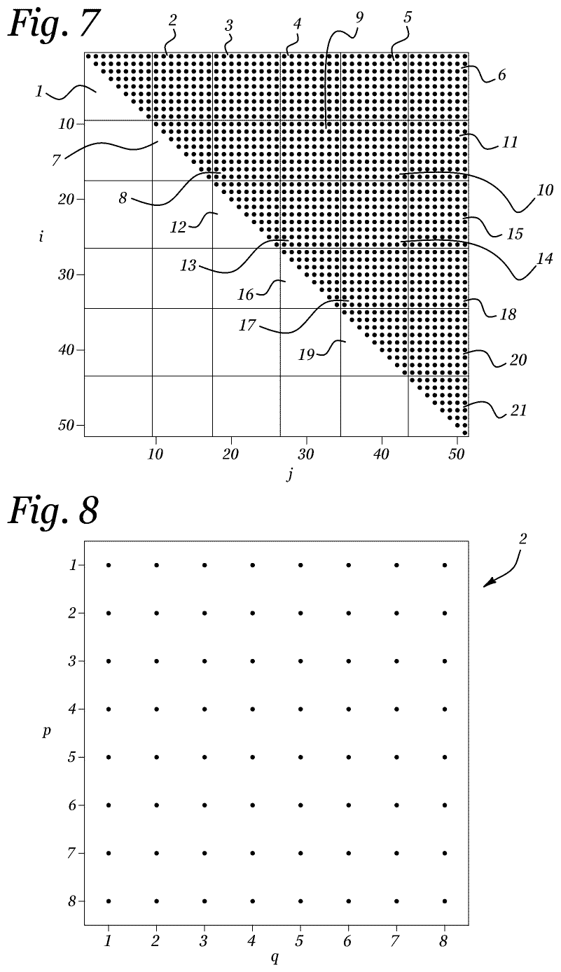

blocks to compute. In the present example, where K=6, this means 21 there are in fact only blocks of cross-correlations need to be computed, as indicated schematically in FIG. 7.

The present inventors have recognised that it is beneficial from a computational efficiency perspective if each block of computations is handled by a single processor. In other words, cross-correlations of the signals for a given pair of subsets should be handled by the same processor. This allows independent and parallel computation of the respective blocks. In the present case, this is easy to facilitate because K has been chosen based on the available computing resources, in particular the number of processors, N_{proc}, available for performing the computation. As a result, the subsets and resulting number of blocks can be efficiently split between the processors.

For example, in the case of FIG. 7, each of the three available processors can process three subsets, which works out as seven blocks for each processor. For example, the subsets and blocks of FIG. 7 can be split as follows:
Processor 1: subsets 1 and 6; blocks 1, 2, 3, 4, 5, 6, 21
Processor 2: subsets 2 and 5; blocks 7, 8, 9, 10, 11, 19, 20
Processor 3: subsets 3 and 4; blocks 12, 13, 14, 15, 16, 17, 18
   As can be seen, in this manner each of the three available processors handles the same number of subsets and resulting blocks of cross-correlations, ensuring an efficient distribution of computing work across the available resource. This is possible because the number of blocks, defined by

$$\frac{K ( K + 1 )}{2} ,$$

is a multiple of three (the number of processors). It will be appreciated that the choice of K=6 would also be efficient in the case that there were seven processors, because then the 21 blocks (defined by

$$\frac{K ( K + 1 )}{2} )$$

would again divide equally between the number of processors (seven). This demonstrates how the choice of K, i.e. the number of subsets, can be informed by the number of available processors and how this can be used to ensure efficient computation of the signal data.

In more general terms, an even distribution of subsets across the available processors can be ensured by splitting the computational burden evenly between the available processors. This ensures that, assuming all processors operate at the same speed, processors take the same amount of time to process a block of cross-correlations, before they look for a new block to compute. As noted, one way of ensuring an even distribution of work between processors is to choose K such that the number of blocks (which is defined by

$$\frac{K ( K + 1 )}{2} )$$

is a multiple of the number of available processors, N_{proc}, as demonstrated by the example described above.

It will be appreciated that some of the blocks of FIG. 7 require fewer computations than others, because they lie on the diagonal of the 2D matrix. In the example of FIG. 7, these blocks are numbered as blocks 1, 7, 12, 16, 19 and 21 respectively. Again, to ensure efficient distribution of computation, it can be ensured that “full” blocks and “half” blocks are distributed as evenly as possible between processors.

By splitting up the signal data into subsets and ensuring that cross-correlation blocks are processed independently by respective processors, the cross-correlation computation can be made far more efficient and manageable than if the entire N by N matrix were treated as a single entity to be computed as a whole. In particular, subsets (and their associated blocks of cross-correlations) can be processed independently and in parallel, significantly reducing the compute time. As demonstrated above, the particular breakdown of the signal data can be determined based on the available computing resource, such that this efficiency can be further enhanced because there is a precise match between the distribution of labour and the available computing resources. These increases in efficiency make what was previously a computationally infeasible task more manageable.

A skilled reader will appreciate that there are a number of ways to perform the cross-correlations for each pair of signal data subsets, in other words for cross-correlating each block of signals. One example approach, which uses a loop-based mechanism (particularly involving so-called “for” loops), will now be described to aid understanding. However, it will be appreciated that other ways of performing the cross-correlations can be used.

The example approach for computing the cross-correlations described below is based on the fundamental relation that cross-correlation between two-vectors in the time domain writes as:

$${g}_{ij} ( t ) = \int {s}_{i} ( τ - t ) {s}_{j} ( τ ) d τ \qquad ( 6 )$$

where g_{i,j} is the time domain Green's function for signals sᵢ and sⱼ. Signals sᵢ and sⱼ are the time domain signals obtained by receivers i and j respectively. t is the timelag for which the cross-correlation function is computed, and t is the integration variable (time).

In the frequency domain, equation 6 can be written as:

$${G}_{ij} ( ω ) = {{S}_{i} ( ω )}^{*} \cdot {S}_{j} ( ω ) \qquad ( 7 )$$

where now G_{i,j} is the frequency domain Green's function for signals Sᵢ and Sⱼ. ω is the (angular) frequency.
Frequency and time domain variables can be equated using a Fourier transform, FT, as:

$${S}_{i} = F T ( {s}_{i} ) ;$$

$${S}_{j} = F T ( {s}_{j} ) ; and$$

$${G}_{ij} = F T ( {G}_{ij} ) .$$

The Fourier transform may be a fast Fourier transform (FFT). Note that

$${G}_{j i} = {G}_{ij}^{*} ,$$

confirming the symmetry referred to above which means that pairs of signals only need to be cross-correlated once.

As noted above, the signal data can be split into K signal data subsets. Each subset can then be numbered as Nₙ, n=1 . . . . K. As noted above, preferably each subset is of size

$$[ \frac{N}{K} ] - 1 or [ \frac{N}{K} ] .$$

Each subset can itself be represented as a 2D matrix of size (Nₙ, M) which can be denoted Wₙ, n=1 . . . . K for simplicity. It is beneficial to map each signal within a given subset to a particular receivers. In other words, it is useful to be able to translate from a “local” view of a signal within a subset, Wₙ, to a signal within the context of the entire signal dataset, St. This can be done using a mapping function, for example:

$${W}_{n} ( p , r ) = {S}_{ind ( n , p )} ( r ) , n = 1 … K , p = 1 … {N}_{n} , r = 1 … M \qquad ( 8 )$$

where p represents a receiver number within a subset and r represents a sample (i.e. frequency) of the total number of M samples.

In equation 8, ind is the aforementioned mapping function which maps indices within a subset to indices within the whole dataset. Accordingly, this mapping function maps each signal within a given subset to a particular receiver. ind is defined by:

$$i n d ( n , p ) = p + {\sum }_{k = 1}^{n - 1} {N}_{k} \qquad ( 9 )$$

where k is a varying index which counts the number of subsets prior to the current subset being mapped.

Similarly, the subset which Wₙ is being cross-correlated with can be defined as:

$${W}_{m} ( q , r ) = {S}_{ind ( m , q )} ( r ) , m = 1 … K , q = 1 … {N}_{m} , r = 1 … M \qquad ( 10 )$$

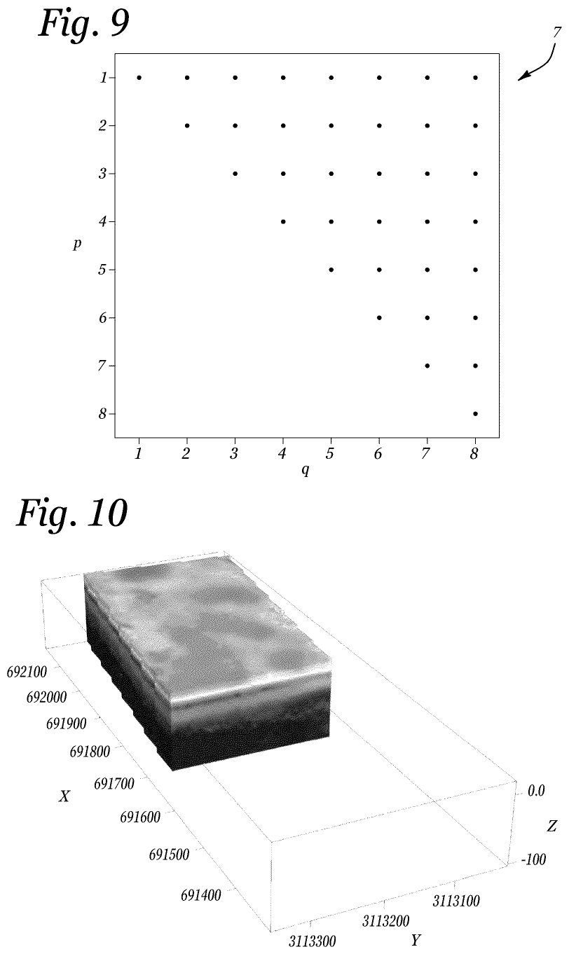

Mapping from the global i, j matrix to a localised p, q matrix using this mapping function provides a “local” view of a block of cross-correlations at the subset level, which can be computed independently of other blocks of cross-correlations. Two example blocks of cross-correlations mapped in this manner are shown in FIGS. 8 and 9. As can be seen, i, j indices from the global matrix of FIG. 7 have now been replaced by “local” p, q indices. The blocks of FIGS. 8 and 9 can now be computed entirely independently of one another, as will now be explained.

Each block (i.e. the 2D matrix of cross-correlations associated with each pairwise cross-correlation of two subsets) can be computed independently, optionally by a plurality of processors. Represented in a high level loop-based notation, this computation can be represented as the cross-correlation of subset Wₙ with subset Wₘ, performed as follows:

$$for n = 1 … K$$

$$for m = n … K$$

$$do compute {C}_{n m} .$$

In other words, compute the cross-correlation of each block, defined by subset Wₙ and subset Wₘ.

This process may also be written as a parallelisable loop, with blocks numbered from 1 to

$$\frac{K ( K + 1 )}{2}$$

as shown in FIG. 7. In this case, the loop can be written as:

$$for b = 1 … \frac{K ( K + 1 )}{2}$$

$$\begin{matrix}n = ceil ( K + 0.5 - \sqrt{{( K + 0.5 )}^{2} - 2 b )} & find line indice \\ m = b - ( n - 1 ) \cdot ( K - n / 2 ) & find column indice \\ do compute {C}_{n m} & \end{matrix}$$

where “ceil” is an operator which rounds up to the next integer value, equivalent to [ ] used above.

It will be appreciated from inspection of FIG. 7 that, to ensure efficient computation, “half” blocks should be treated differently to the “full” blocks, because they involve fewer cross-correlations. Accordingly, different loops can be utilised for processing “half” and “full” blocks respectively.

Turning first to the “full” blocks (i.e. blocks 2, 3, 4, 5, 6, 8, 9, 10, 11, 13, 14, 15, 17, 18 and 20 in FIG. 7), where m #n, these are essentially 2D matrices of signals having local indices p and q as shown in FIG. 8, which shows block 2 from FIG. 7 as an example. Each point represents a cross-correlation between the two signals indicated on the respective axes. Cross-correlation of the signals of these “full” blocks can be performed as:

$$for p = 1 … {N}_{n}$$

$$for q = 1 … {N}_{m}$$

$$for r = 1 … M$$

$${C}_{n m} ( p , q , r ) = {W}_{n}^{*} ( p , r ) \cdot {W}_{m} ( q , r )$$

In other words, for each vector pair Wₙ(p,:), Wₘ(q,:), the standard cross-correlation operation is performed in the frequency domain.

Turning next to the “half” blocks (i.e. blocks 1, 7, 12, 16, 19 and 21 of FIG. 7), where m=n, in this case each subset is cross-correlated with itself. A similar computation is performed as described above for the full blocks, except in that the computation takes into account that there are fewer cross-correlations in these half blocks due to the symmetry reasons described above. As in the case of the full blocks, the half blocks can also be treated as 2D matrices of signals having local indices p and q. An example is shown in FIG. 9, which shows block 7 from FIG. 7. Each point again represents a cross-correlation between the two signals indicated on the respective axes. Cross-correlation of the signals of these “half” blocks can be performed as:

$$for p = 1 … {N}_{n}$$

$$for q = p … {N}_{n}$$

$$for r = 1 … M$$

$${C}_{n n} ( p , q , r ) = {W}_{n}^{*} ( p , r ) \cdot {W}_{n} ( q , r )$$

By using these respective processes for full and half blocks, cross-correlations for each block (i.e. each pair of signal data subsets) can be computed. As mentioned above, because each block is handled independently, the disclosed methods can make use of parallelisation, where multiple processors work on multiple blocks independently and in parallel. Because the division of the signal data into subsets is done based on the available computing resources (e.g. number of processors), an efficient division of labour can be ensured, such that each processor performs the optimum amount of computation in parallel with all other processors.

While the above description has been provided in the context of loop-based computations (specifically so-called “for” loops), it will be appreciated that all of the loops described above are merely examples provided to aid understanding. The cross-correlation computation can alternatively be done in a vectorized manner. Vectorization is a process whereby a processor can perform the same process on each value of a vector or matrix simultaneously. Vectorisation can remove the need of “for” loops of the sort described above. Other mechanisms for performing the cross-correlations are available and the precise implementation will depend on the programming language being used, as will be apparent to a skilled reader.

As described above in relation to step 509 of FIG. 5, each cross-correlation of a pair of receiver signals results in a Green's function. The way in which these resulting Green's functions are then processed, stored and used will depend on the specific context in which the method is being used. In general terms, the Green's functions can be used to investigate sub-surface structures and characteristics, for example by performing tomographic inversion using the Green's functions to generate a three-dimensional model of a target region of the surface on which the receivers are provided. For example, the one or more material properties of the target region can be modelled in the manner described above and below in relation to FIG. 10.

To facilitate use of the Green's functions obtained through cross-correlation of each subset of signals, it is beneficial to store the Green's functions in a manner that allows their local position within the subset they were computed alongside to be mapped easily to their global position within the N by N matrix as a whole and, more particularly, to a particular pair of receivers. This can be facilitated by storing each obtained Green's function in memory alongside an indicator which maps the Green's function to a particular pair of receivers. As an example approach, every time a block is computed each of the Cₙₘ(p, q) signals associated with the block can be saved in memory with a suitable file name or another indicator (e.g. provided in metadata) which identifies the correct indices Guj such that the data file can be mapped to the respective receiver pair to which it relates. In an example, this mapping is represented by:

$$i = i n d ( n , p )$$

$$j = ind ( m , q )$$

wherein the ind operator is defined as above in equation 9. Alternatively, a table can be used to store indications mapping Green's functions to their respective receiver pairs.

With the respective Green's functions appropriately stored in memory, portions of the original 2D matrix of cross-correlations can be reconstructed in whatever manner is required by the given implementation. For example, if all the Green's functions relating to receiver 1 are of interest, these can be easily obtained from storage based on the mapping indicator associated with the stored Green's functions—the system simply needs to obtain the Green's functions with associated mapping indicators G_{1,j}.

The Green's functions obtained through the above method may be used in a variety of ways to investigate the structure and properties of the surface and sub-surface volume on which the receivers are placed. The details of these implementations are beyond the scope of the present disclosure and will be apparent to a skilled person familiar with the use of Green's functions in the context of seismology.

In at least one implementation, following acquisition of data indicative of ambient noise, and the analysis of said ambient noise data to model a plurality of response signals at a plurality of virtual source-receiver pairs, the received data may now be used to determine the ground properties of the sub-surface target volume by solution of an inverse problem, in which the response at the receivers (e.g. receivers 104) is known but the ground properties of the sub-surface target volume is not (yet) known.

The starting model for the solution of the inverse problem may be determined in multiple ways since it sets initial physical property values, for example for Vs, within the sub-surface target volume, to be refined by solution of the inverse problem. The starting model can comprise historical data based on known local or regional data, predicted values based on selective invasive test methods, coarse surface level studies or a theoretical model based on local or regional historical knowledge. Although the starting model is to be improved upon and need not be a particularly accurate representation of the sub-surface target region, the more accurately the starting model reflects the physical properties of the sub-surface target region, the more accurate the final model of the ground properties of the target region will be. Therefore, improvements in the starting model can provide an improved output for the methods and systems described herein. Once a starting model has been selected, the inverse problem can be solved via inversion, as explained below in connection with the example model shown in FIG. 10.

FIG. 10 shows a 3D shear-velocity Vs model for a sub-surface target region of interest. The region of interest was “imaged” to a depth of around 100 m through acquisition of ambient noise data using

receivers. X, Y and Z co-ordinates in meters are shown. The recorded noise data signals were cross-correlated in the manner described above to efficiently generate a set of Green's functions. Tomographic inversion was then performed based on the Green's functions to obtain the 3D model shown. In particular, the inter-receiver travel-times of the surface wave modes were obtained to derive group velocity dispersion curves as a function of frequency and location. From this, a 3D model of seismic shear-wave velocity (Vs) was obtained, which is shown in FIG. 10. Different velocities are represented in different colours (darker areas generally representative of higher velocities) and transitions between regions of different shear wave velocity are clearly visible. These factors indicate the varying composition and structure of portions of the sub-surface target region, providing valuable insight into the constitution of the target region, for example in terms of ground stiffness distribution and soil classification, and thus its suitability as a site for possible construction projects.

The above description has provided a variety of examples to illustrate the disclosed methods. However, the described arrangements and methods are merely exemplary, and it will be appreciated by a person skilled in the art that various modifications can be made without departing from the scope of the appended claims. In particular, all example values for variables such as N, K etc. are merely exemplary. In reality, N will likely be far greater than 51 and K will likely be far greater than 6. These low values are used simply to aid understanding. The advantages of the disclosed methods are particularly beneficial when N is large. The use of geophones in the examples and Figures is merely illustrative and other types of receiver can be used to implement the disclosed techniques.

While various specific combinations of components and method steps have been described, these are merely examples. Components and method steps may be combined or ordered in any suitable arrangement or combination. Components and method steps may also be omitted to leave any suitable combination of components or method steps.

FIG. 11 shows a block diagram of one implementation of a computing device 1100 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein. More particularly, a number of computing devices can be used to compute cross-correlations of signal data subsets independently and in parallel, as described above. Each computing device may have the structure shown in FIG. 11. Alternatively, a plurality of processors within a single computing device, such as computing device 1100, can perform the independent computations.

The example computing device 1100 includes a processor 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a secondary memory (e.g., a data storage device 1118), which communicate with each other via a bus 1130.

Processor 1102 represents one or more general-purpose processors such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processors such as an application specific integrated circuit (ASIC), a field programmable gate array (FPGA), a digital signal processor (DSP), network processor, or the like. Processor 1102 is configured to execute the processing logic (instructions 1122) for performing the operations and steps discussed herein.

The computing device 1100 may further include a network interface device 1108. The computing device 1100 also may include a video display unit 1110 (e.g., a liquid crystal display (LCD) or a cathode ray tube (CRT)), an alphanumeric input device 1112 (e.g., a keyboard or touchscreen), a cursor control device 1114 (e.g., a mouse or touchscreen), and an audio device 1116 (e.g., a speaker).

It will be apparent that some features of computer device 1100 shown in FIG. 11 may be absent. For example, one or more computing devices 1100 may have no need for display device 1110 (or any associated adapters). This may be the case, for example, for particular server-side computer apparatuses 1100 which are used only for their processing capabilities and do not need to display information to users. Similarly, user input device 1112 may not be required. In its simplest form, computing device 1100 comprises processor 1102 and memory 1104.

The data storage device 1118 may include one or more machine-readable storage media (or more specifically one or more non-transitory computer-readable storage media) 1128 on which is stored one or more sets of instructions 1122 embodying any one or more of the methodologies or functions described herein. The instructions 1122 may also reside, completely or at least partially, within the main memory 1104 and/or within the processor 1102 during execution thereof by the computer system 1100, the main memory 1104 and the processor 1102 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of cross-correlating signals detected by receivers, the method comprising:
receiving signal data comprising a plurality of signals detected by a plurality of receivers arranged on a surface;
determining an amount of processing resource that is available for processing the received signal data;
splitting the received signal data into a plurality of signal data subsets based on the determined amount of available processing resource;
cross-correlating, using the available processing resource, pairs of signal data subsets such that each signal data subset is cross-correlated with every other signal data subset and with itself, wherein cross-correlating a pair of signal data subsets comprises cross-correlating each signal in a first subset of the pair with every signal in a second subset of the pair; and
outputting a Green's function resulting from each cross-correlation.

2. The computer-implemented method of claim 1, wherein:
the signal data comprises N signals;
splitting the received signal data into the plurality of signal data subsets comprises splitting the received signal data into K signal data subsets; and
a number of signals in each subset is equal to either
$$[ \frac{N}{K} ] - 1 or [ \frac{N}{K} ] ,$$
where indicates rounding up to a next integer value.

3. The computer-implemented method of claim 1, wherein determining the amount of processing resource that is available for processing the received signal data comprises determining:
a number of available processors, N_{proc}; and
an amount of available random access memory, RAM.

4. The computer-implemented method of claim 3, wherein a number of subsets, K, is chosen such that
$$\frac{K ( K + 1 )}{2}$$
is a multiple or the number of available processors, N_{proc}.

5. The computer-implemented method of claim 3, wherein splitting the received signal data into the plurality of signal data subsets comprises splitting the received signal data into K signal data subsets, where K is chosen according to:
$$K \geq CN \sqrt{\frac{{MDN}_{proc}}{RAM}}$$
where
C is a constant to account for ad-hoc memory requirements;
N is a number of signals comprised in the signal data;
M is a number of samples in each signal;
D is a storage file size of each sample;
N_{proc} is the number of available processors; and
RAM is the amount of available random access memory, RAM.

6. The computer-implemented method of claim 1, wherein the cross-correlating is performed by a plurality of processors.

7. The computer-implemented method of claim 6, wherein all cross-correlations for a given pair of signal data subsets are performed by a same processor.

8. The computer-implemented method of claim 6, wherein each processor performs its cross-correlation(s) independently of and/or in parallel to the other processors.

9. The computer-implemented method of claim 1, wherein each signal data subset is only cross-correlated once with itself and with every other signal data subset.

10. The computer-implemented method of claim 1, wherein a mapping function is used to map each signal within a given subset to a particular receiver.

11. The computer-implemented method of claim 10, further comprising storing each Green's function in memory alongside an indicator mapping the Green's function to a specific pair of receivers.

12. The computer-implemented method of claim 1, wherein the cross-correlating is performed in a frequency domain and the Green's functions are frequency domain Green's functions.

13. The computer-implemented method of claim 1, wherein the receivers comprise geophones, optionally configured to measure a vertical component of vibrations at the surface.

14. The computer-implemented method of claim 1, wherein each signal in the plurality of signals is indicative of ambient noise measured at or near the surface by a respective receiver.

15. A system comprising:
one or more processors:
one or more memories storing instructions, which when executed by the one or more processors cause the system to:
receive signal data comprising a plurality of signals detected by a plurality of receivers arranged on a surface;
determine an amount of processing resource that is available for processing the received signal data;
split the received signal data into a plurality of signal data subsets based on the determined amount of available processing resource;
cross-correlate, using the available processing resource, pairs of signal data subsets such that each signal data subset is cross-correlated with every other signal data subset and with itself, wherein cross-correlating a pair of signal data subsets comprises cross-correlating each signal in a first subset of the pair with every signal in a second subset of the pair; and
output a Green's function resulting from each cross-correlation.

16. The system of claim 15, wherein:
the signal data comprises N signals;
splitting the received signal data into the plurality of signal data subsets comprises splitting the received signal data into K signal data subsets; and
a number of signals in each subset is equal to either
$$[ \frac{N}{K} ] - 1 or [ \frac{N}{K} ] ,$$
where [ ] indicates rounding up to a next integer value.

17. The system of claim 15, wherein determining the amount of processing resource that is available for processing the received signal data comprises determining:
a number of available processors, N_{proc}; and
an amount of available random access memory, RAM.

18. The system of claim 17, wherein a number of subsets, K, is chosen such that
$$\frac{K ( K + 1 )}{2}$$
is a multiple of the number of available processors, N_{proc}.

19. The system of claim 17, wherein splitting the received signal data into the plurality of signal data subsets comprises splitting the received signal data into K signal data subsets, where K is chosen according to:
$$K \geq CN \sqrt{\frac{{MDN}_{proc}}{RAM}}$$
where
C is a constant to account for ad-hoc memory requirements;
N is a number of signals comprised in the signal data;
M is a number of samples in each signal;
D is a storage file size of each sample;
N_{proc} is the number of available processors; and
RAM is the amount of available random access memory, RAM.

20. The system of claim 15, wherein the cross-correlating is performed by a plurality of processors.
